(19) United States
(12) Patent Application Publication
(10) Pub. No.: US 2026/0145583 A1
(43) Pub. Date: May 28, 2026

(54) HEATING SYSTEM

(71) Applicant: TOYOTA JIDOSHA KABUSHIKI KAISHA, Toyota-shi Aichi-ken (JP)

(72) Inventors: Kazuma AOKI, Toyota-shi Aichi-ken (JP); Noritaka TAKUDA, Okazaki-shi Aichi-ken (JP); Hiroto AMADA, Nagakute-shi Aichi-ken (JP)

(73) Assignee: TOYOTA JIDOSHA KABUSHIKI KAISHA, Toyota-shi Aichi-ken (JP)

(21) Appl. No.: 19/398,547

(22) Filed: Nov. 24, 2025

(30) Foreign Application Priority Data
Nov. 27, 2024 (JP) 2024-206015

(51) Int. Cl. B60L 58/27; H01M 10/615; H01M 10/625; H01M 10/633; H01M 10/6571

(52) U.S. Cl. CPC B60L 58/27; H01M 10/615; H01M 10/625; H01M 10/633; H01M 10/6571; H01M 2220/20

(57) ABSTRACT

A heating system configured to efficiently raise a temperature of an electric storage device before charging while avoiding a wasteful power consumption. The heating system comprises: an integrator that calculates an integrated value of power consumed by an electric heater to raise a temperature of a battery; a power consumption determiner that compares the integrated value of the power consumption with a reference value; and a heating controller that terminates the heating of the battery when the integrated value of the power consumption is the reference value or greater, and permits the heating of the battery when the integrated value of the power consumption is less than the reference value.

### CROSS-REFERENCE TO RELATED APPLICATIONS

The present disclosure claims the benefit of Japanese Patent Application No. 2024-206015 filed on Nov. 27, 2024 with the Japanese Patent Office, the disclosures of which are incorporated herein by reference in its entirety.

### BACKGROUND

### Field of the Disclosure

The embodiment of the present disclosure relates to the art of a heating system for raising a temperature of an electric storage device, and more specifically, to a heating system for an electric storage device arranged in a vehicle.

### Discussion of the Related Art

In the prior art, there is known that a charging speed of a secondary battery relates to a temperature of the battery. For example, JP-A-2020-195253 discloses a vehicle battery charge control device configured to charge a battery quickly by charging the battery by electric power suppled from an external charging facility while raising a temperature of the battery by the electric power. However, if an amount of the electric power for raising the temperature of the battery is controlled based only on the temperature of the battery, the temperature of the battery may not be raised promptly and it may take longer to charge the battery. According to the teachings of JP-A-2020-195253, therefore, a distribution rate of the charging power to the heater is increased when a temperature rise rate of the battery in a predetermined time is less than a predetermined value.

However, the charge control device described in JP-A-2020-195253 is configured to start heating of the battery by connecting a charging cable to the vehicle after the vehicle arrives at the charging facility. Therefore, a temperature of the battery at the beginning of charging is low and hence a charging speed at the beginning of the charging is slow.

In order to avoid such technical disadvantage, a preconditioning of a battery may be effective to raise a temperature of the battery before starting a charging of the battery. However, the preconditioning is executed by activating a heater by an electric power of the battery before the vehicle arrives at the charging facility, and hence the electric power may become insufficient and the vehicle may not reach the place where the charging facility is installed. In the prior art, an effective technique to raise a temperature of a battery before charging the battery during propulsion is not available. Therefore, it is necessary to develop an innovative technique to efficiently charge a battery of an electric vehicle.

### SUMMARY

The embodiment of the present disclosure has been conceived noting the foregoing technical problems, and it is therefore an object of the present disclosure to provide a heating system configured to efficiently raise a temperature of an electric storage device before charging while avoiding a wasteful power consumption.

According to one aspect of the present disclosure, there is provided a heating system comprising: an electric heater that heats an electric storage device arranged in a vehicle to raise a temperature of the electric storage device before charging the electric storage device by an external charging facility; and a controller that controls a heating of the electric storage device by the electric heater. In order to achieve the above-explained objective, according to the exemplary embodiment of the present disclosure, the controller comprises: an integrator that is configured to calculate an integrated value of an electric power consumed by the electric heater to raise the temperature of the electric storage device; a power consumption determiner that is configured to compare the integrated value of the electric power calculated by the integrator with a reference value; and a heating controller that is configured to terminate the heating of the electric storage device by the electric heater when the power consumption determiner determines that the integrated value calculated by the integrator is the reference value or greater, and permit the heating of the electric storage device by the electric heater when the power consumption determiner determines that the integrated value calculated by the integrator is less than the reference value.

In a non-limiting embodiment, the controller may further comprise a selector that is configured to select a heating mode of the electric storage device from a manual mode in which the heating of the electric storage device is executed upon execution of a manual operation by an occupant of the vehicle, and an automatic mode in which the heating of the electric storage device is executed based on a detection signal of a condition of the vehicle. In addition, the reference value may include a first reference value which is employed in the manual mode, and a second reference value which is set to a different value from the first reference value and which is employed in the automatic mode.

In a non-limiting embodiment, the second reference value may be set to a value greater than the first reference value.

In a non-limiting embodiment, the integrator may include: a first integrator that is configured to calculate an integrated value of the electric power consumed by the electric heater to raise the temperature of the electric storage device in the manual mode; and a second integrator that is configured to calculate an integrated value of the electric power consumed by the electric heater to raise the temperature of the electric storage device in the automatic mode. In addition, the power consumption determiner may be further configured to compare the integrated value calculated by the first integrator with the first reference value in the manual mode, and compare the integrated value calculated by the second integrator with the second reference value in the automatic mode.

In a non-limiting embodiment, the heating system may further comprise a heat sensor that detects an amount of energy consumed by the electric heater to raise the temperature of the electric storage device. In addition, the integrator is further configured to calculate the integrated value of the electric power consumed by the electric heater to raise the temperature of the electric storage device: by integrating an amount of the energy detected by the heat sensor; or based on a length of time from a point at which the heating of the electric storage device is commenced and an amount of the energy consumed per predetermined unit of time, in a situation where the amount of energy consumed by the electric heater cannot be detected by the heat sensor.

In a non-limiting embodiment, the controller may further comprise a heating inhibitor that is configured to maintain the cessation of the heating of the electric storage device after the heating of the electric storage device is terminated by the heating controller, and inhibit the heating of the electric storage device until a predetermined condition is satisfied.

In a non-limiting embodiment, the predetermined condition may include a first condition that is employed in the manual mode, and a second condition different from the first condition that is employed in the automatic mode.

In a non-limiting embodiment, the first condition may include a fact that a main switch is turned off, and the second condition may include a commencement of the charging of the electric storage device by the external charging facility.

According to another aspect of the present disclosure, there is provided a heating system comprising: an electric heater that heats an electric storage device arranged in a vehicle to raise a temperature of the electric storage device before charging the electric storage device by an external charging facility; and a controller that controls a heating of the electric storage device by the electric heater. In order to achieve the above-explained objective, according to the exemplary embodiment of the present disclosure, the controller comprises: a selector that is configured to select a heating mode of the electric storage device from a manual mode in which the heating of the electric storage device is executed upon execution of a manual operation by an occupant of the vehicle, and an automatic mode in which the heating of the electric storage device is executed based on a detection signal of a condition of the vehicle; and a heating inhibitor that is configured to: maintain a cessation of the heating of the electric storage device in the manual mode after terminating the heating of the electric storage device, and inhibit a restart of the heating of the electric storage device until a first condition is satisfied; and maintain a cessation of the heating of the electric storage device in the automatic mode after terminating the heating of the electric storage device, and inhibit a restart of the heating of the electric storage device until a second condition is satisfied.

In a non-limiting embodiment, the first condition may include a fact that a main switch is turned off, and the second condition may include a commencement of the charging of the electric storage device by the external charging facility.

In a non-limiting embodiment, the heating inhibitor may be further configured to: permit the restart of the heating of the electric storage device in the automatic mode when the first condition is not satisfied but the second condition is satisfied; and permit the heating of the electric storage device in the manual mode when the second condition is not satisfied but the first condition is satisfied.

Thus, according to the exemplary embodiment of the present disclosure, the electric power consumed by the electric heater to raise the temperature of the electric storage device is integrated. If the integrated value of the electric power consumed by the electric heater to raise the temperature of the electric storage device is the reference value or greater, the heating of the electric storage device by the electric heater is terminated. By contrast, if the integrated value of the electric power consumed by the electric heater to raise the temperature of the electric storage device is less than the reference value, the heating of the electric storage device by the electric heater is permitted. According to the exemplary embodiment of the present disclosure, therefore, the electric power will not be consumed more than the reference value to raise the temperature of the electric storage device. That is, the electric power will not be consumed excessively and unnecessarily. In addition, even if the heating of the electric storage device is ceased temporarily for some reason but the integrated value of the power consumption has not yet reached the reference value, the electric storage device may be heated again until the integrated value of the power consumption reaches the reference value. According to the exemplary embodiment of the present disclosure, therefore, the temperature of the electric storage device may be raised certainly to a target temperature level.

According to the exemplary embodiment of the present disclosure, the reference value includes: the first reference value as an upper limit value of the integrated value of the electric power consumed by the electric heater to raise the temperature of the electric storage device in the manual mode; and the second reference value as an upper limit value of the integrated value of the electric power consumed by the electric heater to raise the temperature of the electric storage device in the automatic mode. As described, the first reference value and the second reference value are set to different values. According to the exemplary embodiment of the present disclosure, therefore, the temperature of the electric storage device may be raised accurately in each mode. Specifically, the second reference value is set greater than the first reference value. Therefore, the electric heater is allowed to be activated and inactivated repeatedly to heat the electric storage device in the automatic mode, that is, the electric heater is allowed to consume the electric power repeatedly to heat the electric storage device in the automatic mode. For this reason, the temperature of the electric storage device may be raised sufficiently by the electric heater.

In addition, a comparison between the integrated value of the power consumption in the manual mode and the first reference value, and a comparison between the integrated value of the power consumption in the automatic mode and the second reference value may be conducted separately. That is, the heating of the electric storage device in one of the heating modes will not be restricted by a condition in the other heating mode. According to the exemplary embodiment of the present disclosure, therefore, the electric storage device may be heated appropriately in each of the heating modes.

According to the exemplary embodiment of the present disclosure, an amount of energy such as the electric power consumed to raise the temperature of the electric storage device may be detected by the heat sensor including a current sensor and a voltage sensor, and the integrated value of the electric power consumed to raise the temperature of the electric storage device may be obtained based on the amount of the electric power detected by the heat sensor. Otherwise, in a situation where the amount of electric power consumed by the electric heater to raise the temperature of the electric storage device cannot be obtained based on the amount of the electric power detected by the heat sensor, the integrated value of the electric power consumed to raise the temperature of the electric storage device may also be obtained based on a length of time to energize the electric heater to raise the temperature of the electric storage device and a power consumption by the electric heater per unit of time estimated based on a rated specification of the electric heater. According to the exemplary embodiment of the present disclosure, therefore, an amount of the electric power to be consumed to raise the temperature of the electric storage device may be optimized with or without the heat sensor.

According to the exemplary embodiment of the present disclosure, once the heating of the electric storage device is terminated or ceased by the heating controller, the heating of the electric storage device is inhibited until the predetermined condition is satisfied. According to the exemplary embodiment of the present disclosure, therefore, the electric storage device will not be heated unnecessarily.

As described, the predetermined condition includes the first condition that is employed in the manual mode, and the second condition different from the first condition that is employed in the automatic mode. Specifically, the first condition includes the fact that a main switch is turned off, and the second condition may include the commencement of the charging of the electric storage device by the external charging facility. According to the exemplary embodiment of the present disclosure, therefore, the heating of the electric storage device will not be restarted excessively and the electric power will not be consumed wastefully to restart the e heating of the electric storage device.

As also described, according to the exemplary embodiment of the present disclosure, the heating mode of the electric storage device may be selected from the manual mode and the automatic mode, and the conditions to restart the heating of the electric storage device in the manual mode and in the automatic mode are different. According to the exemplary embodiment of the present disclosure, therefore, the restart of the heating of the electric storage device in each of the heating modes will not be restricted unnecessarily, and the electric power will not be consumed excessively to heat the electric storage device.

Specifically, in the manual mode, the restart of the heating of the electric storage device is permitted when the main switch is turned off. Therefore, the electric power will not be consumed wastefully even if the driver of the vehicle executes the manual operation repeatedly by mistake. Whereas, in the automatic mode, the restart of the heating of the electric storage device is permitted when the charging of the electric storage device is commenced. Therefore, the electric storage device is heated in a condition where the electric storage device is charged sufficiently. For this reason, the vehicle is allowed to be propelled without hindrance while heating the electric storage device.

In addition, the restart of the heating of the electric storage device is permitted and inhibited separately in each of the heating modes. Therefore, the restart of the heating of the electric storage device in any one of the heating modes will not be restricted unnecessarily even if the condition to inhibit the restart of the heating of the electric storage device in other one of the heating modes is satisfied. In addition, the heating of the electric storage device in any one of the heating modes will not be restarted unnecessarily and the electric power will not be consumed excessively by such unnecessary execution of the heating of the electric storage device, even if the condition to cancel the inhibition of the heating of the electric storage device in other one of the heating modes is satisfied.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the heating system according to the exemplary embodiment of the present disclosure is applied;

FIG. 2 is a line chart showing changes in a temperature of the electric storage device in the manual heating mode and in the automatic heating mode;

FIG. 3 is a block diagram showing functions of the controller;

FIG. 4 is a flowchart showing a routine according to the first control example executed by the controller;

FIG. 5 is a time chart showing changes in an operating condition of a main switch, an existence of a heating demand in the manual mode, a heating state, a state of a heating flag, an integrated value of power consumption, and a determination of excessive power consumption, during execution of the first control example;

FIG. 6 is a flowchart showing a routine according to the second control example executed by the controller;

FIG. 7 is a time chart showing changes in an operating condition of the main switch, an existence of a heating demand in the automatic mode, a state of a charging flag, a heating state, a state of the heating flag, an integrated value of power consumption, and a determination of excessive power consumption, during execution of the second control example;

FIG. 8 is a flowchart showing a routine according to the third control example executed by the controller;

FIG. 9 is a time chart showing changes in an operating condition of the main switch, an existence of a heating demand in the manual mode, the heating state, a temperature of the electric storage device, a determination of completion of the heating, and a state of a completion flag, during execution of the third control example;

FIG. 10 is a flowchart showing a routine according to the fourth control example executed by the controller; and

FIG. 11 is a time chart showing changes in an operating condition of the main switch, an existence of a heating demand in the automatic mode, a state of the charging flag, a heating state, a temperature of the electric storage device, a determination of completion of the heating, and a state of the completion flag, during execution of the fourth control example.

### DETAILED DESCRIPTION OF THE EMBODIMENT(S)

An embodiment of the present disclosure will now be explained with reference to the accompanying drawings. Note that the embodiments shown below are merely examples of the present disclosure, and do not limit the present disclosure.

### Structure of Vehicle

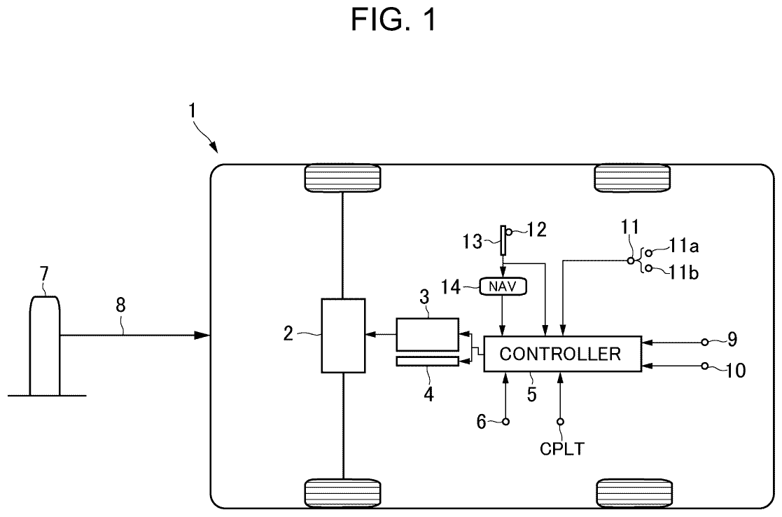

Referring now to FIG. 1, there is shown one example of a structure of a vehicle 1 to which the heating system according to the exemplary embodiment of the present disclosure is applied. The vehicle 1 shown in FIG. 1 is an electric vehicle in which a prime mover 2 includes an electric motor. In the vehicle 1, an electric power is supplied to the prime mover 2 from an electric storage device 3, and the electric storage device 3 may be charged with an electric power generated by the electric motor. For example, a secondary battery such as a lithium-ion battery may be adopted as the electric storage device 3. Since a speed to charge the electric storage device 3 (i.e., a charging speed or a charging rate of the electric storage device 3) changes depending on a temperature of the electric storage device 3, the vehicle 1 is provided with an electric heater 4 for heating the electric storage device 3 to raise the temperature of the electric storage device 3 to a level at which the electric storage device 3 can be charged efficiently. To this end, the electric heater 4 is connected with the electric storage device 3 so that electric storage device 3 is heated using the electric power accumulated in the electric storage device 3.

The electric heater 4 is controlled by a controller 5 to heat the electric storage device 3, that is, to raise the temperature of the electric storage device 3. The controller 5 comprises a central processing unit (i.e., a CPU), a memory element (including a ROM, a RAM, and a SRAM), and an interface, and performs a calculation based in incident data using data and programs stored therein. A calculation result is transmitted from the controller 5 in the form of a command signal. The vehicle 1 is activated by turning on a main switch 6 and inactivated by turning off the main switch 6. That is, the main switch serves as an ignition switch or a ready switch, and on/off signals of the main switch 6 are transmitted to the controller 5. Here, it is to be noted that the controller 5 may be operated even when the main switch 6 is off.

In addition, a pilot control signal (hereinafter abbreviated as the CPLT signal) is transmitted to the controller 5. The electric storage device 3 may also be charged by connecting the electric storage device 3 with an external charging facility 7 installed in a charging station through a charging cable 8. Therefore, when the charging cable 8 is connected to the charging facility 7, the PCLT signal controlling charging of the electric storage device 3 is transmitted between the charging facility 7 and the vehicle 1. The PCLT signal transmitted to the vehicle 1 is inputted to the controller 5.

In order to control the temperature of the electric storage device 3, detection signals are also transmitted to the controller 5 from a temperature sensor 9 that detects the temperature of the electric storage device 3 and an external temperature sensor 10 that detects an external temperature. In addition, a detection signal is also transmitted to the controller 5 from a heat sensor 11 that detects an amount of energy (i.e., an amount of heat) consumed by the electric heater 4 to raise the temperature of the electric storage device 3. Specifically, the heat sensor 11 includes a current sensor 11a that detects an electric current supplied from the electric storage device 3 to the electric heater 4, and a voltage sensor 11b. Instead, a sensor adapted to obtain an electric consumption based on a temperature of the electric storage device 3 raised by heating the electric storage device 3 and a heat capacity of the electric storage device 3 may also be employed as the heat sensor 11.

The controller 5 is configured to select a heating mode of the electric storage device 3 from a manual heating mode (hereinafter simply referred to as the manual mode) and an automatic heating mode (hereinafter simply referred to as the automatic mode). In the manual mode, the heating of the electric storage device 3 is started upon execution of a manual operation by a driver or user (i.e., an occupant) of the vehicle 1, and terminated upon satisfaction of a predetermined condition, e.g., when the temperature of the electric storage device is raised to a target level. Whereas, in the automatic mode, the heating of the electric storage device 3 is started upon reception of a detection signal of a condition of the vehicle 1, e.g., a detection signal of a location of the vehicle 1, and also terminated upon satisfaction of a predetermined condition, e.g., when the temperature of the electric storage device is raised to a target level. In order to select the heating mode, a selection signal is transmitted to the controller 5 from a selector switch 12. For example, a contact relay such as a push switch and a touch sensitive switch indicated in a touch panel 13 in the form of an icon may be adopted as the selector switch 12. In the vehicle 1 shown in FIG. 1, the selector switch 12 is indicated in a touch panel 13.

### Heating Mode

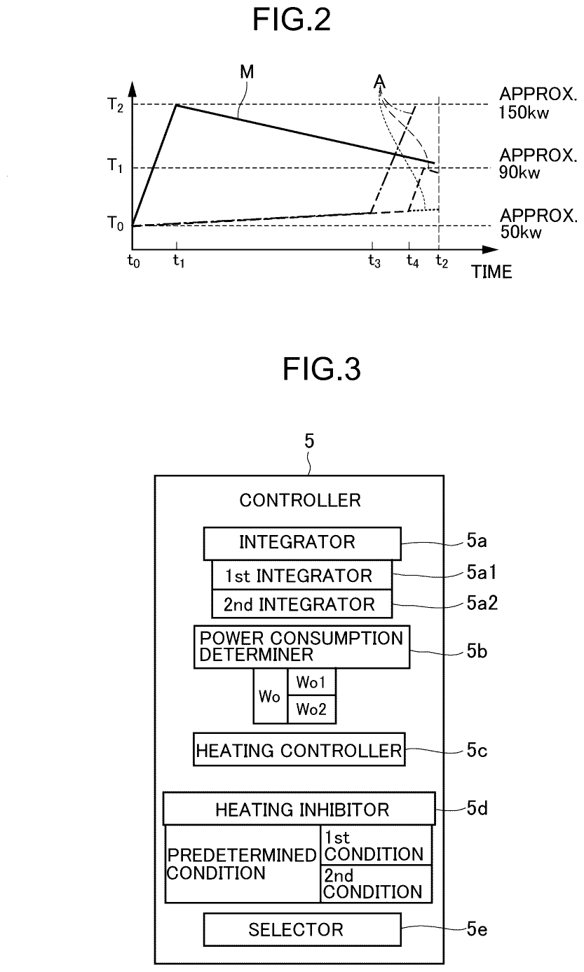

Here will be explained the manual mode and the automatic mode in more detail. The manual mode is selected to raise the temperature of the electric storage device 3 by the electric heater 4 for the preparation of charging the electric storage device 3 by the charging facility 7. Specifically, the manual mode is selected by operating the selector switch 12 to select the manual mode during propulsion of the vehicle 1 or in the situation where the main switch 6 is on. Changes in the temperature of the electric storage device 3 in the manual mode and the automatic mode are indicated in FIG. 2. In FIG. 2, the vertical axis represents the temperature of the electric storage device 3, the horizontal axis represents time, the solid curve represented by the letter “M” indicates a change in the temperature of the electric storage device 3 in the manual mode, and the dashed curves represented by the letter “A” indicate changes in the temperature of the electric storage device 3 in the automatic mode. At point t0, the manual mode is selected by operating the selector switch 12. Consequently, the electric heater 4 is energized to heat the electric storage device 3 so that the temperature of the electric storage device 3 is raised gradually from point t0. In this situation, an increase rate of the temperature of the electric storage device 3 is governed by an amount of heat generated by the electric heater 4, a thermal resistance between the electric heater 4 and the electric storage device 3, a radiation amount from the electric storage device 3 according to an external temperature and so on.

An optimum temperature level of the electric storage device 3 at which the electric storage device 3 may be charged efficiently differs according to a charging capacity of the charging facility 7. For example, given that the charging capacity of the charging facility 7 is approximately 50 Kw, the optimum temperature level of the electric storage device 3 is approximately T0° C. Given that the charging capacity of the charging facility 7 is approximately 90 Kw, the optimum temperature level of the electric storage device 3 is approximately T1(>T0)° C. Given that the charging capacity of the charging facility 7 is approximately 150 Kw, the optimum temperature level of the electric storage device 3 is approximately T2(>T1)° C. In the manual mode, if the electric storage device 3 is not going to be charged, or if the electric storage device 3 is going to be charged but a capacity of the charging facility 7 is unknown, the temperature level corresponding to the maximum charging capacity of the charging facility 7 (i.e., T2° C.) is employed as a target temperature level and the temperature of the electric storage device 3 is raised to T2° C. When the temperature of the electric storage device 3 is raised to T2° C. at point t1, the power supply to the electric heater 4 is stopped so that the temperature the electric storage device 3 is no longer raised. Then, the heat of the electric storage device 3 is dissipated naturally so that the temperature of the electric storage device 3 is gradually lowered. Consequently, the temperature of the electric storage device 3 may fall below the optimum temperature level at point t2 at which the electric storage device 3 is charged. Therefore, in the manual mode, the temperature of the electric storage device 3 is raised in line with the intension of the driver who selected the manual mode by operating the selector switch 12.

Whereas, in the automatic mode, the temperature of the electric storage device 3 is raised automatically in accordance with conditions of the vehicle 1 including a distance from a current location of the vehicle 1 to the charging facility 7, and an estimated time to arrive at the charging facility 7. For example, a location of the charging facility 7 may be found with reference to a map data. Otherwise, the location of the charging facility 7 may be set as a destination in a navigation system 14. Thus, in the automatic mode, the temperature of the electric storage device 3 is raised based on data about the current position or location of the vehicle 1 and data about the location of the charging facility 7 collected by the navigation system 14. Specifically, the navigation system 14 is configured to specify the locations of the vehicle 1 and the charging facility 7 by detecting the locations of the vehicle 1 and the charging facility 7 utilizing a GPS (i.e., global positioning system), and superimposing the positional information collected by the GPS on the map data. Therefore, the distance from the current location of the vehicle 1 to the charging facility 7, and the estimated time (or an estimated clock time) to arrive at the charging facility 7 in accordance with a speed of the vehicle 1 may be obtained by the navigation system 14. In addition, charging capacities of the charging facilities 7 may be stored in the navigation system 14 in advance.

A required time to raise the temperature of the electric storage device 3 to the target temperature level may be obtained based on a difference between the current temperature of the electric storage device 3 and the target temperature level. Accordingly, a timing to start the heating of the electric storage device 3, that is, a clock time or a distance to the charging facility 7 to start the heating of the electric storage device 3 may be determined based on the required time and the current speed of the vehicle 1. For example, given that the charging capacity of the charging facility 7 as the destination for which the vehicle 1 is headed is 150 Kw and that the automatic mode is selected, the heating of the electric storage device 3 is started from point t3 as indicated by the dashed-dotted curve represented by the symbol “A”. Whereas, given that the charging capacity of the charging facility 7 as the destination for which the vehicle 1 is headed is 90 Kw and that the automatic mode is selected, the heating of the electric storage device 3 is started when the vehicle 1 comes closer to the charging facility 7, that is, from point t4 as indicated by the dashed curve also represented by the symbol “A”. In the automatic mode, the heating of the electric storage device 3 is also terminated when the temperature of the electric storage device 3 is raised to the target temperature level.

In addition, various kinds of reference values and criterion values for determining conditions of the electric storage device 3 and the vehicle 1 are stored in the controller 5. For example, a reference value of an amount of energy (i.e., an amount of electric power) consumed by the electric heater 4 is stored in the controller 5.

### Functions of the Controller

The controller 5 is configured to execute and terminate or cease the heating of the electric storage device 3, and to inhibit and permit a restart of the heating of the electric storage device 3, based on the incident data and the data stored therein. As shown in FIG. 3, the controller 5 comprises an integrator 5a, a power consumption determiner 5b, a heating controller 5c, a heating inhibitor 5d, and a selector 5e. The integrator 5a is configured to calculate an amount of energy consumed by the electric heater 4 to raise the temperature of the electric storage device 3. Specifically, the integrator 5a calculates an integrated value of an electric power consumed by the electric heater 4 to raise the temperature of the electric storage device 3, by integrating an amount of the electric power consumed by the electric heater 4 obtained based on a current value detected by the current sensor 11a and a voltage value detected by the voltage sensor 11b. Otherwise, in a situation where the amount of power consumed by the electric heater 4 to raise the temperature of the electric storage device 3 cannot be obtained based on the current value and the voltage value, the integrator 5a calculates the amount of power consumed by the electric heater 4 based on a power consumption by the electric heater 4 per unit of time and a length of time to energize the electric heater 4 to raise the temperature of the electric storage device 3. As shown in FIG. 3, the integrator 5a includes a first integrator 5a1 that integrates the amount of energy (i.e., the electric power) consumed by the electric heater 4 to raise the temperature of the electric storage device 3 in the manual mode, and a second integrator 5a2 that integrates the amount of energy (i.e., the electric power) consumed by the electric heater 4 to raise the temperature of the electric storage device 3 in the automatic mode.

The power consumption determiner 5b is configured to compare the integrated value of the power consumption calculated by the integrator 5a with a reference value W0. Specifically, the power consumption determiner 5b is configured to determine whether the integrated value of the electric power consumed by the electric heater 4 to raise the temperature of the electric storage device 3 is the reference value W0 or greater, or less than the reference value W0. As described, the amount of power consumption may be integrated separately in the manual mode and the automatic mode. Therefore, the reference value Wo includes a first reference value Wo1 which is employed in the manual mode, and a second reference value Wo2 which is employed in the automatic mode.

The heating controller 5c is configured to permit and inhibit the execution of the heating of the electric storage device 3. For example, the heating controller 5c ceases or terminates the heating of the electric storage device 3 when the integrated value of the power consumption calculated by the integrator 5a is the reference value Wo or greater. By contrast, the heating controller 5c permits the heating of the electric storage device 3 when the integrated value of the power consumption calculated by the integrator 5a is less than the reference value Wo. As described, such determination of execution of the heating may be made separately in the manual mode and the automatic mode. Specifically, in the manual mode, the amount of power consumption integrated by the first integrator 5a1 is compared with the first reference value Wo1 to terminate or permit the heating of the electric storage device 3. Whereas, in the automatic mode, the amount of power consumption integrated by the second integrator 5a2 is compared with the second reference value Wo2 to terminate or permit the heating of the electric storage device 3. In embodiments, the second reference value Wo2 may be set to a greater value than the first reference value Wo1. In the automatic mode, the heating of the electric storage device 3 may be terminated and restarted repeatedly depending on a travelling route determined by the navigation system 14 thereby increasing the amount of power consumption to raise the temperature of the electric storage device 3. Therefore, the second reference value Wo2 is set greater than the first reference value Wo1.

The heating inhibitor 5d is configured to maintain the cessation of the heating of the electric storage device 3 after the heating of the electric storage device 3 is ceased by the heating controller 5c, and inhibit the heating of the electric storage device 3 until a predetermined condition is satisfied. That is, a large electric power may be consumed to raise the temperature of the electric storage device 3, therefore, the heating inhibitor 5d restricts the execution of the heating of the electric storage device 3 after ceasing the heating of the electric storage device 3. To this end, the above-mentioned predetermined condition includes a first condition employed in the manual mode and a second condition employed in the automatic mode. Specifically, in order to avoid an excessive temperature rise in the electric storage device 3 by executing the heating randomly by the driver during propulsion of the vehicle 1 or while the main switch 6 is on, the first condition includes a condition that the main switch 6 is off. On the other hand, the second condition includes a condition that a charging of the electric storage device 3 by the charging facility 7 is started. For example, such commencement of the charging operation may be detected based on the CPLT signal. The automatic mode is selected while the vehicle 1 travels toward the charging facility 7, and the purpose of selecting the automatic mode to heat the electric storage device 3 before charging is attained when the charging of the electric storage device 3 is commenced. Therefore, the commencement of the charging of the electric storage device 3 may be employed as the second condition.

Thus, different controls are executed in the manual mode and the automatic mode. Specifically, different integrators and different reference values are employed in the manual mode and the automatic mode. The heating mode of the electric storage device 3 is selected from the manual mode and the automatic mode by the selector 5e based on the signal transmitted thereto from the selector switch 12, and the controller 5 executes the heating operation of the electric storage device 3 in the selected heating mode.

### First Control Example

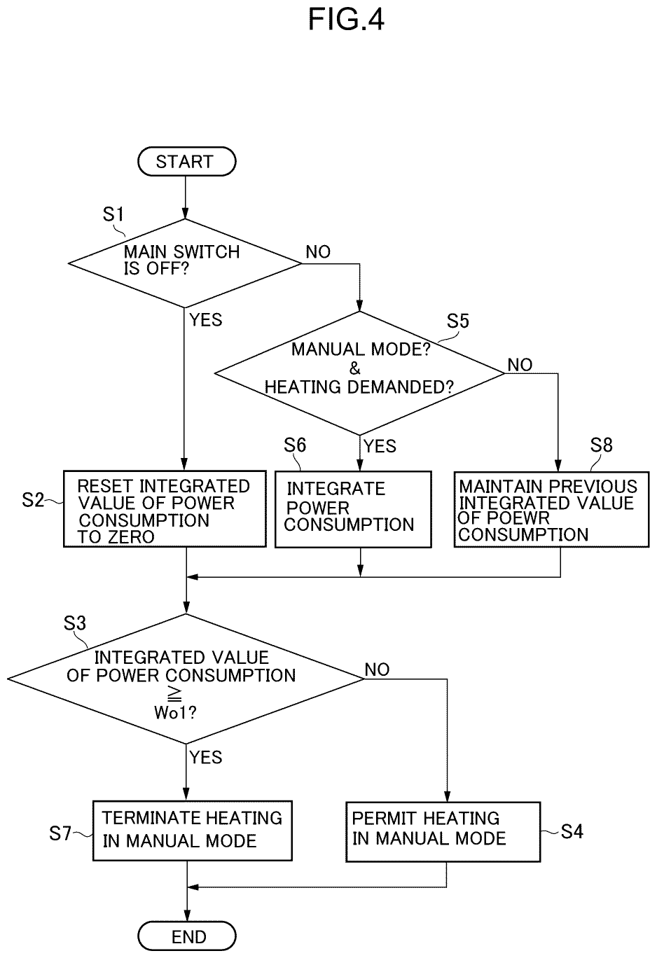

Turning to FIG. 4, there is shown a routine according to the first control example executed by the controller 5 in the manual mode. The routine shown in FIG. 4 is executed repeatedly at predetermined time intervals. At step S1, it is determined whether the main switch 6 is off. In a situation where the main switch 6 is off, the power supply to the prime mover 2 from the electric storage device 3 and the heating of the electric storage device 3 by the electric heater 4 are stopped, and the navigation system 14 is inactivated.

If the main switch 6 is off so that the answer of step S1 is YES, the routine progresses to step S2 to reset the integrated value of the power consumption stored in e.g., the SRAM to zero. In other words, the routine progresses to step S2 to clear the integrated value of the electric power consumed by the electric heater 4 to rase the temperature of the electric storage device 3. Then, it is determined at step S3 whether the integrated value of the power consumption is equal to or greater than the reference value Wo. In this case, since the manual mode is selected, it is determined at step S3 whether the integrated value of the power consumption is equal to or greater than the first reference value Wo1. For example, the first reference value Wo1 may be set at design phase based on the capacities of the electric storage device 3 and the electric heater. In this situation, the main switch 6 is off and hence the integrated value of the power consumption has been reset to zero. Therefore, the answer of step S3 in this situation is NO, and the routine progresses to step S4 to permit the heating of the electric storage device 3 in the manual mode after launching the vehicle 1, and thereafter returns. Thus, the fact that the main switch 6 is off is the condition to permit the heating of the electric storage device 3 in the manual mode. In other words, the fact that the main switch 6 is off is the condition to cancel the inhibition of the heating of the electric storage device 3 in the manual mode.

By contrast, in a case that the vehicle 1 has already launched, that is, in a case that the main switch 6 is on so that the answer of step S1 is NO, the routine progresses to step S5 to determine whether the manual mode is selected and the heating of the electric storage device 3 is demanded. For example, the heating of the electric storage device 3 is demanded if the temperature of the electric storage device 3 is lower than the target temperature level, and the manual mode is selected by operating the selector switch 12 to select the manual mode. If the manual mode is selected and the heating of the electric storage device 3 is demanded so that the answer of step S5 is YES, the heating of the electric storage device 3 is commenced in the manual mode, and the routine progresses to step S6 to integrate the electric power consumed by the electric heater 4 to raise the temperature of the electric storage device 3. In this situation, since the manual mode is selected, the electric power consumed by the electric heater 4 is integrated by the first integrator 5a1.

Then, the routine further progresses to step S3 to determine whether the integrated value of the power consumption is equal to or greater than the first reference value Wo1. In the initial phase of the heating of the electric storage device 3, the power consumption is still small so that the answer of step S3 is NO. In this case, therefore, the routine progresses to step S4 to permit the heating of the electric storage device 3 so that the heating of the electric storage device 3 in the manual mode is continued. The integrated value of the power consumption increases gradually while the heating of the electric storage device 3 is continued. When the integrated value reaches the first reference value Wo1, the routine progresses from step S3 to step S7 to terminate or cease the heating of the electric storage device 3 in the manual mode during propulsion of the vehicle 1, and thereafter returns.

If the selector switch 12 is operated to shift the heating mode from the manual mode to the automatic mode, or if the temperature of the electric storage device 3 has been raised to the target temperature level, the heating of the electric storage device 3 is no longer demanded. That is, the demand for the heating of the electric storage device 3 disappears. If the heating of the electric storage device 3 is no longer demanded so that the answer of step S5 is NO, the routine progresses from step S5 to step S8 to maintain the integrated value of the power consumption obtained at step S6, that is, to maintain the integrated value of the power consumption to the previous value. Thereafter, the routine further progresses to step S3 to determine whether the integrated value of the power consumption maintained to the previous value is equal to or greater than the first reference value Wo1.

In a case that the demand for the heating of the electric storage device 3 disappears while the heating of the electric storage device 3 is still continued so that the answer of step S5 is NO, the previous value of the integrated value of the power consumption has not yet reaches the first reference value Wo1, that is, the previous value of the integrated value of the power consumption is still less than the first reference value Wo1. In this case, therefore, the heating of the electric storage device 3 in the manual mode is permitted, and started again when the manual mode is selected again and if the temperature of the electric storage device 3 is still lower than the target temperature level.

Whereas, in a case that the demand for the heating of the electric storage device 3 disappears after terminating the heating of the electric storage device 3 at step S7 so that the answer of step S5 is NO, the integrated value of the power consumption being maintained to the previous value has already reached the first reference value Wo1. In this case, therefore, the answer of the subsequent step S3 is YES. Consequently, the cessation of the heating of the electric storage device 3 is maintained and the heating of the electric storage device 3 is inhibited until the integrated value of the power consumption falls below the first reference value Wo1. Specifically, such inhibition of the heating of the electric storage device 3 is maintained until the main switch 6 is turned off and an affirmative determination is made at step S1.

Thus, according to the first control example shown in FIG. 4, the heating of the electric storage device 3 in the manual mode is inhibited until the main switch 6 is turned off. Accordingly, the predetermined condition of the exemplary embodiment of the present disclosure includes the fact that the main switch 6 is turned off, and the heating of the electric storage device 3 is inhibited by the heating inhibitor 5d. According to the first control example, the power consumed by the electric heater 4 to heat the electric storage device 3 is limited less than the first reference value Wo1 even if the electric storage device 3 is heated by the electric heater 4 before charging the electric storage device 3. Therefore, the electric power will not be consumed excessively and unnecessarily to raise the temperature of the electric storage device 3.

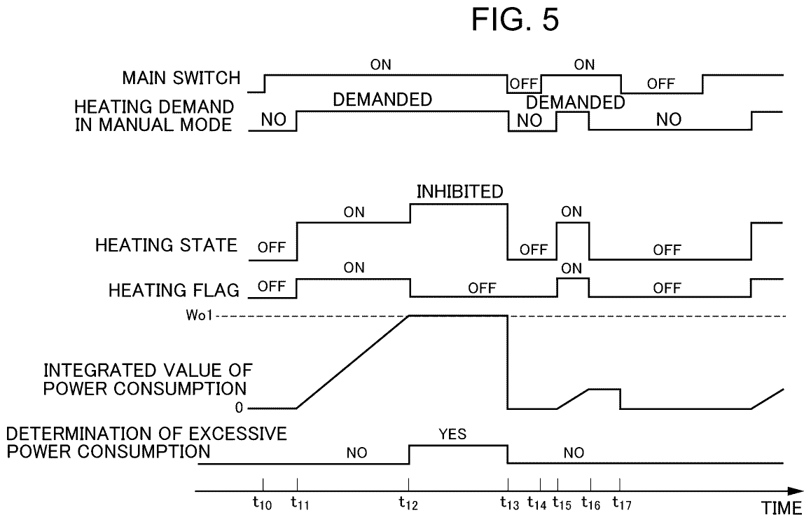

Turning to FIG. 5, there are shown changes in an operating condition of the main switch 6, an existence of the heating demand in the manual mode, a heating state, a state of a heating flag, an integrated value of the power consumption, and a determination of excessive power consumption during execution of the first control example shown in FIG. 4. At point t10, the main switch 6 is turned on so that the vehicle 1 is activated to be propelled. In this situation, the integrated value of the power consumption is reset to zero, and a temperature of the electric storage device 3 is detected by the temperature sensor 9. Then, at point t11, the selector switch 12 is operated to select the manual mode. In this situation, if the temperature of the electric storage device 3 is lower than the target temperature level, the heating of the electric storage device 3 in the manual mode is demanded. In this situation, therefore, the heating flag representing the permission of the heating is turned on so that the electric heater 4 is energized to start the heating of the electric storage device 3. Consequently, the integrated value of the power consumption increases gradually from point t11.

Since the electric power to be supplied to the electric heater 4 is determined in advance, the integrated value of the power consumption increases at a rate governed by the electric power supplied to the electric heater 4. When the integrated value of the power consumption reaches the first reference value Wo1 at point t12, an excessive power consumption is determined. In this situation, therefore, the heating flag is turned off, and the heating of the electric storage device 3 is inhibited. Consequently, the power supply to the electric heater 4 is interrupted thereby stopping the heating of the electric storage device 3. In this situation, although the heating of the electric storage device 3 is still demanded, the integrated value of the power consumption has reached the first reference value Wo1 so that the condition to inhibit the heating of the electric storage device 3 has been satisfied. Therefore, the heating of the electric storage device 3 is ceased, and the electric power is not consumed to heat the electric storage device 3 in this situation.

When the vehicle 1 is stopped and the main switch 6 is turned off at point t13, parameters relating to the heating of the electric storage device 3 are reset. In this situation, therefore, the heating of the electric storage device 3 is no longer demanded, and the heating of the electric storage device 3 is not executed. In addition, the integrated value of the power consumption is reset to zero, and hence the answer of the determination of excessive power consumption changes to NO. Consequently, the inhibition of the heating of the electric storage device 3 in the manual mode is cancelled.

Then, the main switch 6 is turned on again at point t14, and the selector switch 12 is operated to select the manual mode at point t15. In this situation, therefore, the heating of the electric storage device 3 is demanded again, the heating flag is turned on again, and the heating of the electric storage device 3 is commenced again. Consequently, the electric storage device 3 is heated by the electric heater 4 again, and the integrated value of the power consumption increases from zero from point t15. Then, when the selector switch 12 is operated to cancel the manual mode at point t16, the demand to heat the electric storage device 3 disappears. In this situation, therefore, the heating flag is turned off, and the heating of the electric storage device 3 is terminated. However, the integrated value of the power consumption has not yet reached the first reference value Wo1 in this situation, and hence the answer of the determination of excessive power consumption is NO. Nevertheless, the heating of the electric storage device 3 is not inhibited in this situation. Therefore, the heating of the electric storage device 3 by the electric heater 4 will be executed in the manual mode on demand. In this situation, an amount of the electric power consumed by the electric heater 4 from point t14 is integrated. Thereafter, when the main switch is turned off again at point t17, the integrated value of the power consumption is again reset to zero.

### Second Control Example

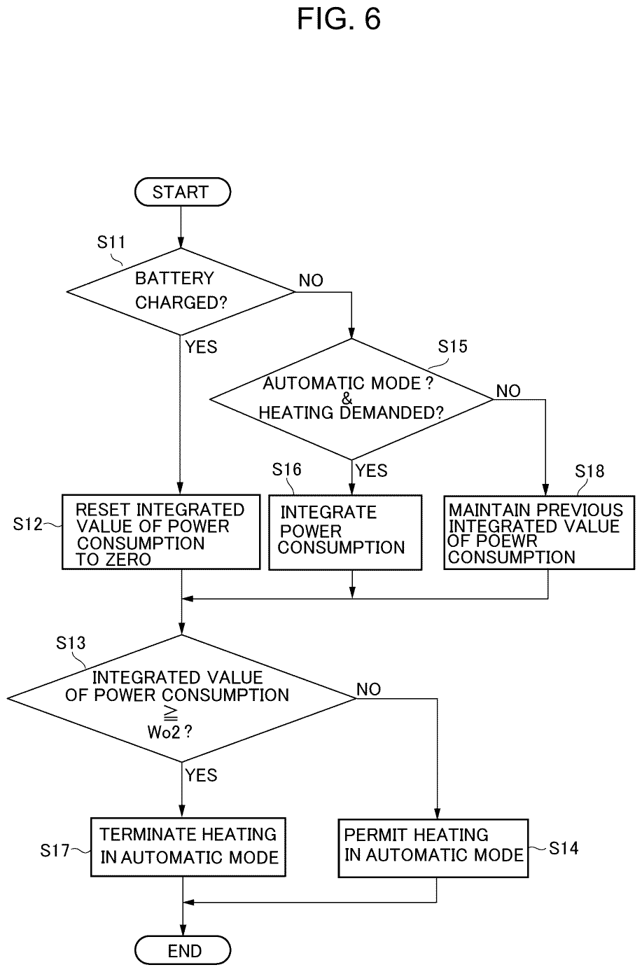

According to the exemplary embodiment of the present disclosure, the heating of the electric storage device 3 in the automatic mode is terminated or inhibited when the integrated value of the power consumption reaches the reference value, and the termination or inhibition of the heating of the electric storage device 3 in the automatic mode is cancelled upon execution of the charging of the electric storage device 3. One example of the heating control of the electric storage device 3 in the automatic mode is shown in FIG. 6. The routine shown in FIG. 6 is executed repeatedly at predetermined time intervals. At step S11, it is determined whether the electric storage device 3 is being charged by the charging facility 7. Specifically, the electric storage device 3 is charged by inserting a plug of the charging cable 8 into an inlet (not shown) of the vehicle 1. An execution of such plug-in charging may be detected based on the CPLT signal.

If the electric storage device 3 is being charged so that the answer of step S11 is YES, the routine progresses to step S12 to reset the integrated value of the power consumption stored in e.g., the SRAM to zero. In other words, the routine progresses to step S2 to clear the integrated value of the electric power consumed by the electric heater 4 to raise the temperature of the electric storage device 3. Then, it is determined at step S13 whether the integrated value of the power consumption is equal to or greater than the reference value Wo. In this situation, since the automatic mode is selected, it is determined at step S13 whether the integrated value of the power consumption is equal to or greater than the second reference value Wo2. As described, the second reference value Wo2 is greater than the first reference value Wo1 employed in the manual mode, and set to an appropriate value at design phase. In this situation, since the integrated value of the power consumption has been reset to zero, the answer of step S13 is NO, and the routine progresses to step S14 to permit the heating of the electric storage device 3 in the automatic mode after launching the vehicle 1. Thereafter the routine returns. Thus, the commencement of the charging of the electric storage device 3 by the charging facility 7 is the condition to permit the heating of the electric storage device 3 in the automatic mode. In other words, the commencement of the charging of the electric storage device 3 by the charging facility 7 is the condition to cancel the inhibition of the heating of the electric storage device 3 in the automatic mode.

By contrast, in the case that the vehicle 1 has already launched, that is, in the case that the electric storage device 3 is not being charged by the charging facility 7 so that the answer of step S11 is NO, the routine progresses to step S15 to determine whether the automatic mode is selected and the heating of the electric storage device 3 is demanded. For example, the heating of the electric storage device 3 is demanded if the temperature of the electric storage device 3 is lower than the target temperature level, and the automatic mode is selected by operating the selector switch 12 to select the automatic mode. If the automatic mode is selected and the heating of the electric storage device 3 is demanded so that the answer of step S15 is YES, the heating of the electric storage device 3 is commenced in the automatic mode, and the routine progresses to step S16 to integrate the electric power consumed by the electric heater 4 to raise the temperature of the electric storage device 3. In this situation, since the automatic mode is selected, the electric power consumed by the electric heater 4 is integrated by the second integrator 5a2.

Then, the routine further progresses to step S13 to determine whether the integrated value of the power consumption is equal to or greater than the second reference value Wo2. In the initial phase of the heating of the electric storage device 3, the power consumption is still small so that the answer of step S13 is NO. In this case, therefore, the routine progresses to step S14 to permit the heating of the electric storage device 3. Consequently, the heating of the electric storage device 3 in the automatic mode is continued. The integrated value of the power consumption increases gradually while the heating of the electric storage device 3 is continued. When the integrated value reaches the second reference value Wo2, the routine progresses from step S13 to step S17 to terminate the heating of the electric storage device 3 in the automatic mode during propulsion of the vehicle 1, and thereafter returns.

If the selector switch 12 is operated to shift the heating mode from the automatic mode to the manual mode, or if the temperature of the electric storage device 3 has been raised to the target temperature level, the heating of the electric storage device 3 is no longer demanded. That is, the demand for the heating of the electric storage device 3 disappears. If the heating of the electric storage device 3 is no longer demanded so that the answer of step S15 is NO, the routine progresses from step S15 to step S18 to maintain the integrated value of the power consumption obtained at step S16, that is, to maintain the integrated value of the power consumption to the previous value. Thereafter, the routine further progresses to step S13 to determine whether the integrated value of the power consumption maintained to the previous value is equal to or greater than the second reference value Wo2.

In a case that the demand to heat the electric storage device 3 disappears while the heating of the electric storage device 3 is still continued and hence the answer of step S15 is NO, the previous value of the integrated value of the power consumption has not yet reaches the second reference value Wo2, that is, the previous value of the integrated value of the power consumption is still less than the second reference value Wo2. In this case, therefore, the heating of the electric storage device 3 in the automatic mode is permitted, and started again when the automatic mode is selected again and if the temperature of the electric storage device 3 is still lower than the target temperature level.

Whereas, in a case that the demand to heat the electric storage device 3 disappears after the integrated value of the power consumption has reached the second reference value Wo2 and the heating of the electric storage device 3 has been terminated at step S17 so that the answer of step S15 is NO, the integrated value of the power consumption being maintained to the previous value has already reached the second reference value Wo2. In this case, therefore, the answer of the subsequent step S13 is YES. Consequently, the cessation of the heating of the electric storage device 3 is maintained and the heating of the electric storage device 3 in the automatic mode is inhibited until the integrated value of the power consumption falls below the second reference value Wo2. Specifically, such inhibition of the heating of the electric storage device 3 is maintained until the charging of the electric storage device 3 by the charging facility 7 is commenced and an affirmative determination is made at step S11.

Thus, according to the second control example shown in FIG. 6, the heating of the electric storage device 3 in the automatic mode is inhibited until the charging of the electric storage device 3 by the charging facility 7 is commenced. Accordingly, the predetermined condition of the exemplary embodiment of the present disclosure includes the commencement of the charging of the electric storage device 3 by the charging facility 7, and the heating of the electric storage device 3 is inhibited by the heating inhibitor 5d. According to the second control example, the power consumed by the electric heater 4 to heat the electric storage device 3 is limited less than the second reference value Wo2 even if the electric storage device 3 is heated by the electric heater 4during propulsion of the vehicle 1 before charging the electric storage device 3. Therefore, the electric power will not be consumed excessively and unnecessarily to raise the temperature of the electric storage device 3.

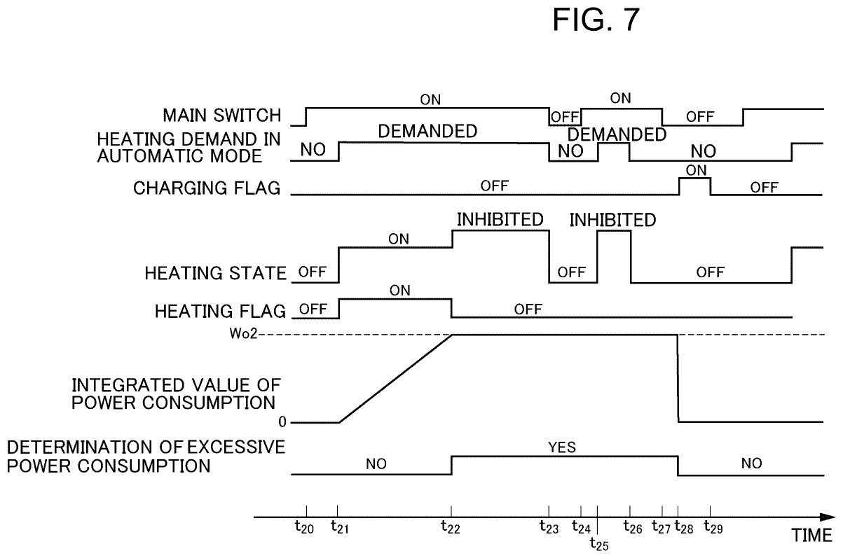

Turning to FIG. 7, there are shown changes in an operating condition of the main switch 6, an existence of the heating demand in the automatic mode, a state of a charging flag, a heating state, a state of the heating flag, an integrated value of the power consumption, and a determination of excessive power consumption during execution of the second control example shown in FIG. 6. At point t20, the main switch 6 is turned on so that the vehicle 1 is activated to be propelled. In this situation, the integrated value of the power consumption is reset to zero, and a temperature of the electric storage device 3 is detected by the temperature sensor 9. Then, at point t21, the selector switch 12 is operated to select the automatic mode. In this situation, if the vehicle 1 has reached a predetermined location within a predetermined distance from the destination where the charging facility 7 is installed, and if the temperature of the electric storage device 3 is lower than the target temperature level, the heating of the electric storage device 3 in the automatic mode is demanded. Therefore, the heating flag representing the execution of the heating is turned on so that the electric heater 4 is energized to start the heating of the electric storage device 3. Consequently, the integrated value of the power consumption increases from point t21.

Since the electric power to be supplied to the electric heater 4 is determined in advance, the integrated value of the power consumption increases at a rate governed by the electric power supplied to the electric heater 4. When the integrated value of the power consumption reaches the second reference value Wo2 at point t22, an excessive power consumption is determined. In this situation, therefore, the heating flag is turned off, and the heating of the electric storage device 3 is inhibited. Consequently, the power supply to the electric heater 4 is interrupted thereby stopping the heating of the electric storage device 3. In this situation, although the heating of the electric storage device 3 is still demanded, the integrated value of the power consumption has reached the second reference value Wo2 so that the condition to inhibit the heating of the electric storage device 3 has been satisfied. Therefore, the heating of the electric storage device 3 is ceased, and the electric power is not consumed to heat the electric storage device 3 in this situation.

When the vehicle 1 is stopped and the main switch 6 is turned off at point t23, parameters relating to the heating of the electric storage device 3 are reset. In this situation, therefore, the heating of the electric storage device 3 is not demanded, and the heating of the electric storage device 3 is ceased. In this situation, however, the charging of the electric storage device 3 by the charging facility 7 has not yet been commenced. Therefore, the answer of the determination of excessive power consumption is still YES, and the integrated value of the power consumption is maintained to the previous value which has increased to the second reference value Wo2. In this situation, specifically, the vehicle 1 once reached the predetermined location within a predetermined distance from the destination where the charging facility 7 is installed and hence the heating of the electric storage device 3 has been commenced, but the vehicle 1 detoured and made an unscheduled stop before arriving at the destination.

Then, the main switch 6 is turned on again to launch the vehicle 1 at point t24, and the selector switch 12 is operated to select the manual mode at point t25. In this situation, although the heating of the electric storage device 3 is demanded, the integrated value of the power consumption has reached the second reference value Wo2 and hence the answer of the determination of excessive power consumption is YES. Therefore, the heating of the electric storage device 3 in the automatic mode is inhibited. In this situation, the integrated value of the power consumption is still maintained to the previous value. Then, when the selector switch 12 is operated to cancel the automatic mode at point t26, the heating demand in the automatic mode disappears and the heating of the electric storage device 3 is terminated. That is, the heating condition is brought into the predetermined default condition, but the remaining operating conditions are maintained.

Then, at point t27, the vehicle 1 arrives at the destination where the charging facility 7 is installed and the main switch 6 is turned off. In this situation, the condition to cancel the inhibition of the heating of the electric storage device 3 in the automatic mode has not yet been satisfied. Therefore, the integrated value of the power consumption is still maintained to the previous value so that the answer of the determination of excessive power consumption is still YES. When the charging cable 8 is connected with the vehicle 1 at point t28, the charging flag representing the execution of the charging is turned on so that the electric storage device 3 is charged from point t28. Consequently, the answer of the determination of excessive power consumption changes to NO, and the integrated value of the power consumption is reset to zero. In this situation, therefore, the inhibition of the heating of the electric storage device 3 is cancelled so that the heating of the electric storage device 3 in the automatic mode is permitted. Thereafter, when the charging of the electric storage device 3 is completed at point t29, the charging cable 8 is disconnected from the vehicle 1 and the charging flag is turned off. Such disconnection of the charging cable 8 from the vehicle 1 may be detected based on the CPLT signal.

### Third Control Example

As explained with reference to FIG. 2, the heating of the electric storage device 3 by the electric heater 4 is completed when the temperature of the electric storage device 3 is raised to the target temperature level. According to the exemplary embodiment of the present disclosure, the heating system is further configured to terminate or inhibit the heating of the electric storage device 3 upon satisfaction of the predetermined condition and to permit the heating of the electric storage device 3 upon satisfaction of another predetermined condition, in a case where the selector switch 12 is operated again to select the manual mode or the temperature of the electric storage device 3 falls below the target temperature level after the termination of the heating.

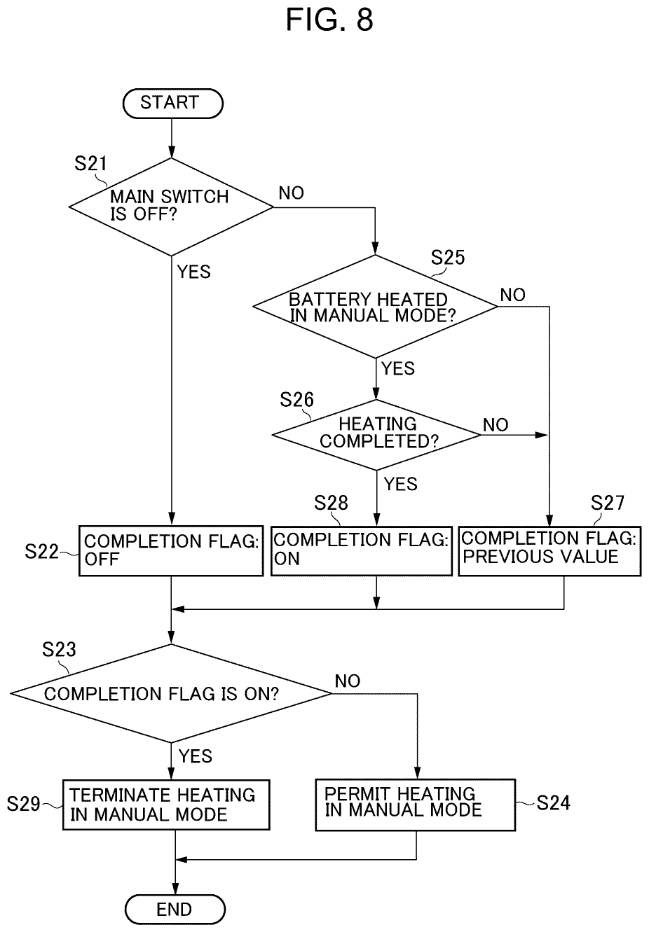

Turning to FIG. 8, there is shown a routine according to the third control example, and the routine shown in FIG. 8 is also executed repeatedly at predetermined time intervals. At step S21, it is determined whether the main switch 6 is off. As described, in the situation where the main switch 6 is off, the power supply to the prime mover 2 from the electric storage device 3 and the heating of the electric storage device 3 by the electric heater 4 are stopped, and the navigation system 14 is inactivated.

If the main switch 6 is off so that the answer of step S21 is YES, the routine progresses to step S22 to turn off a completion flag representing the completion of the heating of the electric storage device 3. According to the exemplary embodiment of the present disclosure, the completion of the heating is determined when the temperature of the electric storage device 3 is raised to the target temperature level. Therefore, the completion flag is turned on when the temperature of the electric storage device 3 is raised to the target temperature level. Then, it is determined at step S23 whether the completion flag representing the completion of the heating of the electric storage device 3 in the manual mode is on. In the case that the main switch 6 is off, the completion flag has been turned off so that the answer of step S23 is NO. In this case, therefore, the routine progresses to step S24 to permit the heating of the electric storage device 3 in the manual mode after launching the vehicle 1, and thereafter returns. Thus, the fact that the main switch 6 is off is the condition to permit the heating of the electric storage device 3 in the manual mode. In other words, the fact that the main switch 6 is off is the condition to cancel the inhibition of the heating of the electric storage device 3 in the manual mode.

By contrast, if the vehicle 1 has already launched, that is, if the main switch 6 is on so that the answer of step S21 is NO, the routine progresses to step S25 to determine whether the manual mode is selected and the electric storage device 3 is being heated by the electric heater 4. Such determination at step S25 may be made based on the fact that the manual mode is selected by the selector switch 12, and the fact that the electric power is being supplied to the electric heater 4.

If the answer of step S25 is YES, the routine progresses to step S26 to determine whether the completion of the heating of the electric storage device 3 is determined. Normally, the heating of the electric storage device 3 by the electric heater 4 is completed when the temperature of the electric storage device 3 is raised to the target temperature level. Therefore, the completion of the heating is determined when the temperature of the electric storage device 3 reaches the target temperature level. For example, in the situations immediately after turning on the main switch 6 or immediately after selecting the manual mode after turning on the main switch 6, the heating of the electric storage device 3 has not yet been commenced. In those situations, therefore, the temperature of the electric storage device 3 is still low, and the answer of step S26 will be NO.

If the temperature of the electric storage device 3 is still low so that the answer of step S26 is NO, the routine progresses to step S27 to maintain the completion flag to the previous state. For example, if the completion flag has been previously turned off, the completion flag is maintained to be off. By contrast, if the completion flag has been previously turned on, the completion flag is maintained to be on. Likewise, if the heating of the electric storage device 3 in the manual mode is not executed so that the answer of step S25 is NO, the routine also progresses to step S27 to maintain the completion flag to the previous state. Then, the routine progresses to step S23 to determine whether the completion flag is on. In the case that the heating of the electric storage device 3 in the manual mode is not executed, or in the case that heating of the electric storage device 3 is executed in the manual mode but the temperature of the electric storage device 3 has not yet been raised to the target temperature level, the completion flag which has been turned off is maintained at step S27. In those cases, therefore, the answer of step S23 is NO and the routine progresses to step S24 to permit or continue the heating of the electric storage device 3 in the manual mode.

Whereas, when the temperature of the electric storage device 3 is raised to the target temperature level as a result of heating the electric storage device 3 in the manual mode, the completion of the heating is determined at step S26. Therefore, if the temperature of the electric storage device 3 is raised to the target temperature level so that the answer of step S26 is YES, the routine progresses to step S28 to turn on the completion flag. Then, the routine further progresses to step S23 to determine whether the completion flag is on. In this case, the answer of step S23 is YES, and the routine further progresses to step S29 to maintain the termination of the heating of the electric storage device 3 and to inhibit the restart of the heating of the electric storage device 3 until the main switch 6 is turned off and the completion flag is turned off at step S22.

Thus, according to the third control example shown in FIG. 8, the heating of the electric storage device 3 in the manual mode is inhibited until the main switch 6 is turned off. Accordingly, the predetermined condition of the exemplary embodiment of the present disclosure includes the fact that the main switch 6 is turned off, and the heating of the electric storage device 3 is inhibited by the heating inhibitor 5d. According to the third control example, once the temperature of the electric storage device 3 is raised to the target temperature level by heating the electric storage device 3 during propulsion of the vehicle 1 prior to charging the electric storage device 3, the electric storage device 3 will not be heated again until the main switch 6 is turned off to terminate the trip of the vehicle 1. Therefore, the electric power will not be consumed excessively and unnecessarily to raise the temperature of the electric storage device 3.

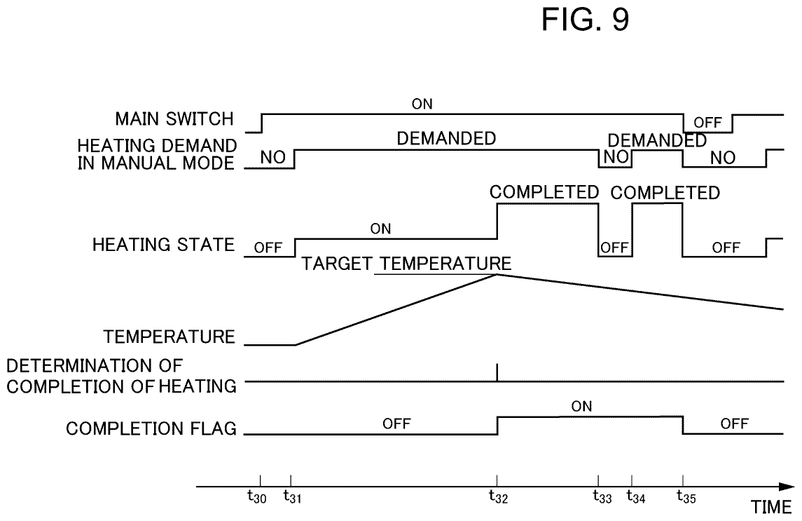

Turning to FIG. 9, there are shown changes in an operating condition of the main switch 6, an existence of the heating demand in the manual mode, a heating state, a temperature of the electric storage device 3, a determination of the completion of the heating, and a state of the completion flag, during execution of the third control example shown in FIG. 8. At point t30, the main switch 6 is turned on so that the vehicle 1 is activated to be propelled. In this situation, the temperature of the electric storage device 3 is detected by the temperature sensor 9. Then, at point t31, the selector switch 12 is operated to select the manual mode. In this situation, if the temperature of the electric storage device 3 is lower than the target temperature level, the heating of the electric storage device 3 in the manual mode is demanded. Therefore, the electric heater 4 is energized to start the heating of the electric storage device 3 so that the temperature of the electric storage device 3 is raised gradually from point t31. Then, when the temperature of the electric storage device 3 is raised to the target temperature level at point t32, the completion of the heating is determined and the completion flag is turned on.

Then, when the selector switch 12 is operated to cancel the manual mode at point t33 and the heating demand in the manual mode disappears, the heating condition is brought into the default condition in which at least the electric storage device 3 is not heated. In this situation, however, the main switch is still on so that the completion flag representing the completion of the heating of the electric storage device 3 in the manual mode is still on. Therefore, in spite of the fact that the selector switch 12 is operated to select the manual mode again and the heating of the electric storage device 3 is demanded again at point t34, the completion of the heating is determined at point t34. In this situation, therefore, the heating of the electric storage device 3 in the manual mode is inhibited, and the electric power will not be supplied to the electric heater 4. That is, the temperature of the electric storage device 3 will not be raised again.

Thereafter, when the vehicle 1 is stopped and the main switch 6 is turned off at point t35, the parameters relating to the heating of the electric storage device 3 are reset. In this situation, therefore, the heating of the electric storage device 3 is no longer demanded, the heating of the electric storage device 3 is terminated, and the completion flag is turned off. Consequently, the inhibition of the heating of the electric storage device 3 in the manual mode is cancelled.

### Fourth Control Example

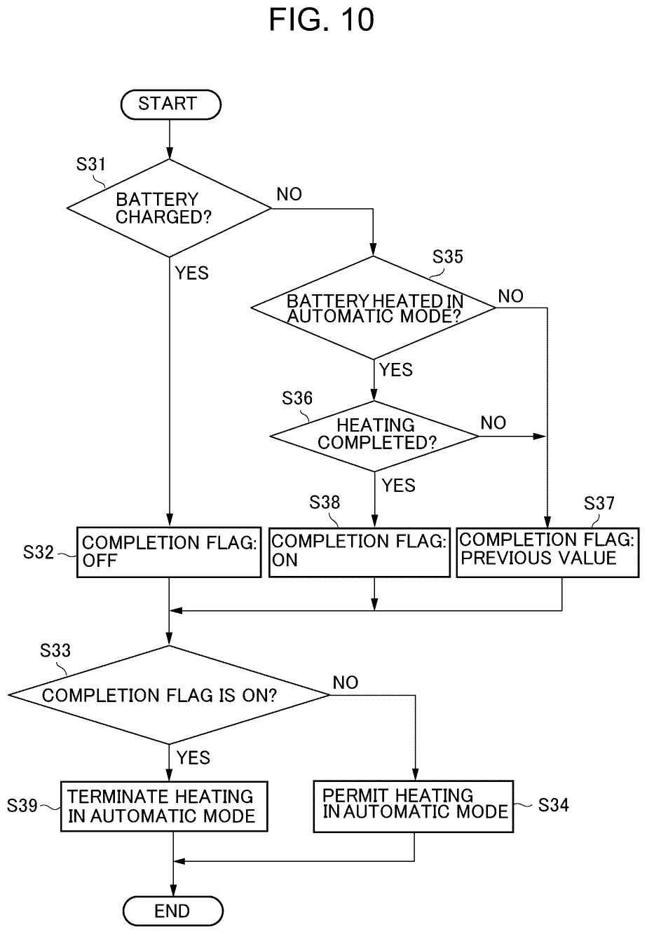

According to the exemplary embodiment of the present disclosure, the heating of the electric storage device 3 in the automatic mode may also be terminated or inhibited when the temperature of the electric storage device 3 is raised to the target temperature level, and the termination or inhibition of the heating of the electric storage device 3 in the automatic mode may also be cancelled upon execution of the charging of the electric storage device 3. Another example of the heating control of the electric storage device 3 in the automatic mode is shown in FIG. 10. The routine shown in FIG. 10 is executed repeatedly at predetermined time intervals. At step S31, it is determined whether the electric storage device 3 is charged by the charging facility 7. As described, the electric storage device 3 is charged by the charging facility 7 by inserting the plug of the charging cable 8 into the inlet (not shown) of the vehicle 1. The execution of such plug-in charging may be detected based on the CPLT signal.

If the electric storage device 3 is being charged so that the answer of step S31 is YES, the routine progresses to step S32 to turn off the completion flag representing the completion of the heating of the electric storage device 3. As described, the completion of the heating is determined when the temperature of the electric storage device 3 is raised to the target temperature level. Therefore, the completion flag is turned on when the temperature of the electric storage device 3 is raised to the target temperature level. Then, it is determined at step S33 whether the completion flag representing the completion of the heating of the electric storage device 3 in the automatic mode is on. If the charging of the electric storage device 3 by the charging facility 7 has already commenced, the completion flag has been turned off so that the answer of step S33 is NO. In this case, therefore, the routine progresses to step S34 to permit the heating of the electric storage device 3 in the automatic mode after launching the vehicle 1, and thereafter returns. Thus, the commencement of the charging of the electric storage device 3 by the charging facility 7 is the condition to permit the heating of the electric storage device 3 in the automatic mode. In other words, the commencement of the charging of the electric storage device 3 by the charging facility 7 is the condition to cancel the inhibition of the heating of the electric storage device 3 in the automatic mode.

By contrast, if the vehicle 1 has already launched, that is, if the electric storage device 3 is not being charged by the charging facility 7 so that the answer of step S31 is NO, the routine progresses to step S35 to determine whether the automatic mode is selected and the electric storage device 3 is being heated by the electric heater 4. Such determination at step S35 may be made based on the fact that the automatic mode is selected by the selector switch 12, and the fact that the electric power is being supplied to the electric heater 4.

If the answer of step S35 is YES, the routine progresses to step S36 to determine whether the completion of the heating of the electric storage device 3 is determined. Normally, the heating of the electric storage device 3 by the electric heater 4 is completed when the temperature of the electric storage device 3 is raised to the target temperature level. Therefore, the determination of the completion of the heating is made when the temperature of the electric storage device 3 reaches the target temperature level. In addition, the heating of the electric storage device in the automatic mode is commenced when the vehicle 1 comes close to the destination where the charging facility 7 is installed. For example, even if the main switch 6 is on, the temperature of the electric storage device 3 has not yet been raised sufficiently in the situation where the vehicle 1 has not yet come close to the destination and the heating of the electric storage device 3 has not yet been commenced, or in the situation immediately after the commencement of the heating of the electric storage device 3. In those situations, therefore, the temperature of the electric storage device 3 is still low, and the answer of step S36 will be NO.

If the temperature of the electric storage device 3 is still low so that the answer of step S36 is NO, the routine progresses to step S37 to maintain the completion flag to the previous state. For example, if the completion flag has been previously turned off, the completion flag is maintained to be off. By contrast, if the completion flag has been previously turned on, the completion flag is maintained to be on. Likewise, if the heating of the electric storage device 3 in the automatic mode is not executed so that the answer of step S35 is NO, the routine also progresses to step S37 to maintain the completion flag to the previous state. Then, the routine progresses to step S33 to determine whether the completion flag is on. In the case that the heating of the electric storage device 3 in the automatic mode is not executed, or in the case that heating of the electric storage device 3 is executed in the automatic mode but the temperature of the electric storage device 3 has not yet been raised to the target temperature level, the completion flag which has been turned off is maintained at step S37. In those cases, therefore, the answer of step S33 is NO and the routine progresses to step S34 to permit or continue the heating of the electric storage device 3 in the automatic mode.

Whereas, when the temperature of the electric storage device 3 is raised to the target temperature level as a result of heating the electric storage device 3 in the automatic mode, the completion of the heating is determined at step S36. Therefore, if the temperature of the electric storage device 3 is raised to the target temperature level so that the answer of step S36 is YES, the routine progresses to step S38 to turn on the completion flag. Then, the routine further progresses to step S33 to determine whether the completion flag is on. In this case, the answer of step S33 is YES, and the routine further progresses to step S39 to maintain the cessation of the heating of the electric storage device 3 and to inhibit the restart of the heating of the electric storage device 3 until the charging of the electric storage device 3 is commenced and the completion flag is turned off at step S32.

Thus, according to the fourth control example shown in FIG. 10, the heating of the electric storage device 3 in the automatic mode is inhibited until the charging of the electric storage device 3 by the charging facility 7 is commenced. Accordingly, the predetermined condition of the exemplary embodiment of the present disclosure includes the commencement of the charging of the electric storage device 3 by the charging facility 7, and the heating of the electric storage device 3 is inhibited by the heating inhibitor 5d. According to the fourth control example, once the temperature of the electric storage device 3 is raised to the target temperature level by heating the electric storage device 3 during propulsion of the vehicle 1 prior to charging the electric storage device 3, the electric storage device 3 will not be heated again until the charging of the electric storage device 3 by the charging facility 7 is commenced. Therefore, the electric power will not be consumed excessively and unnecessarily to raise the temperature of the electric storage device 3.

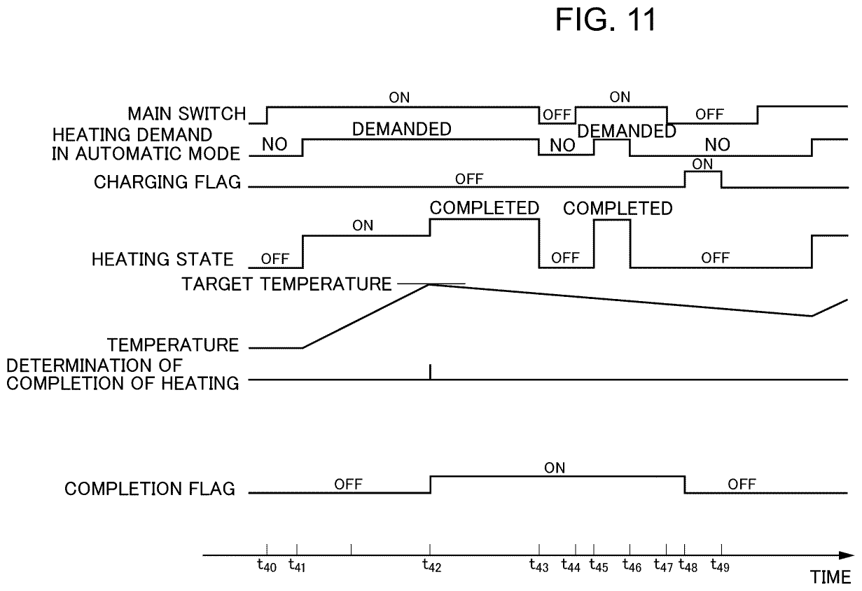

Turning to FIG. 11, there are shown changes in an operating condition of the main switch 6, an existence of the heating demand in the automatic mode, a state of the charging flag, a heating state, a temperature of the electric storage device 3, a determination of the completion of the heating, and a state of the completion flag, during execution of the fourth control example shown in FIG. 10. At point t40, the main switch 6 is turned on so that the vehicle 1 is activated to be propelled. In this situation, the temperature of the electric storage device 3 is detected by the temperature sensor 9. Then, at point t41, the selector switch 12 is operated to select the automatic mode. In this situation, if the temperature of the electric storage device 3 is lower than the target temperature level, the heating of the electric storage device 3 in the automatic mode is demanded when the vehicle 1 reaches the predetermined location within the predetermined distance from the destination where the charging facility 7 is installed. Therefore, the electric heater 4 is energized to start the heating of the electric storage device 3 so that the temperature of the electric storage device 3 is raised gradually from point t41. Then, when the temperature of the electric storage device 3 is raised to the target temperature level at point t42, the completion of the heating is determined and the completion flag is turned on.

Then, when the vehicle 1 is stopped and the main switch 6 is turned off at point t43, the parameters relating to the heating of the electric storage device 3 are reset. In this situation, therefore, the heating demand in the automatic mode disappears and the heating of the electric storage device 3 is ceased. Consequently, the heating condition is brought into the predetermined default condition. Nevertheless, since the electric storage device 3 has not yet been charged by the charging facility 7, the completion flag is maintained to be on. In this situation, specifically, the vehicle 1 once reached the predetermined location within the predetermined distance from the destination where the charging facility 7 is installed and hence the heating of the electric storage device 3 has been commenced, but the vehicle 1 detoured and made an unscheduled stop before arriving at the destination.

Then, the main switch 6 is turned on again to launch the vehicle 1 at point t44, and the selector switch 12 is operated to select the automatic mode at point t45. In this situation, although the heating of the electric storage device 3 is demanded, the completion flag is maintained to be on and hence the heating of the electric storage device 3 in the automatic mode is inhibited. Then, when the selector switch 12 is operated to cancel the automatic mode at point t46, the heating demand in the automatic mode disappears and the heating of the electric storage device 3 is ceased again. In this situation, the heating condition is brought into the predetermined default condition again, but the completion flag is still maintained to be on.

Thereafter, at point t47, the vehicle 1 arrives at the destination where the charging facility 7 is installed and the main switch 6 is turned off. In this situation, the condition to cancel the inhibition of the heating of the electric storage device 3 in the automatic mode has not yet been satisfied. Therefore, the completion flag is still maintained to be on. When the charging cable 8 is connected with the vehicle 1 at point t48, the charging flag representing the execution of the charging is turned on so that the electric storage device 3 is charged from point t48, and the completion flag is turned off. In this situation, therefore, the inhibition of the heating of the electric storage device 3 is cancelled so that the heating of the electric storage device 3 in the automatic mode is permitted. Thereafter, when the charging of the electric storage device 3 is completed at point t49, the charging cable 8 is disconnected from the vehicle 1 and the charging flag is turned off. Such disconnection of the charging cable 8 from the vehicle 1 may be detected based on the CPLT signal.

Although the above exemplary embodiment of the present disclosure has been described, it will be understood by those skilled in the art that the heating system according to the present disclosure should not be limited to the described exemplary embodiment, and various changes and modifications can be made within the scope of the present disclosure. For example, the heating system according to the present disclosure may also be applied to a plug-in hybrid vehicle in which a prime mover includes an electric motor and an internal combustion engine.

What is claimed is:

1. A heating system, comprising:
an electric heater that heats an electric storage device arranged in a vehicle to raise a temperature of the electric storage device before charging the electric storage device by an external charging facility; and
a controller that controls a heating of the electric storage device by the electric heater,
wherein the controller comprises:
an integrator that is configured to calculate an integrated value of an electric power consumed by the electric heater to raise the temperature of the electric storage device;
a power consumption determiner that is configured to compare the integrated value of the electric power calculated by the integrator with a reference value; and
a heating controller that is configured to terminate the heating of the electric storage device by the electric heater when the power consumption determiner determines that the integrated value calculated by the integrator is the reference value or greater, and permit the heating of the electric storage device by the electric heater when the power consumption determiner determines that the integrated value calculated by the integrator is less than the reference value.

2. The heating system as claimed in claim 1,
wherein the controller further comprises a selector that is configured to select a heating mode of the electric storage device from a manual mode in which the heating of the electric storage device is executed upon execution of a manual operation by an occupant of the vehicle, and an automatic mode in which the heating of the electric storage device is executed based on a detection signal of a condition of the vehicle, and
the reference value includes a first reference value which is employed in the manual mode, and a second reference value which is set to a different value from the first reference value and which is employed in the automatic mode.

3. The heating system as claimed in claim 2, wherein the second reference value is set to a value greater than the first reference value.

4. The heating system as claimed in claim 2,
wherein the integrator includes a first integrator that is configured to calculate an integrated value of the electric power consumed by the electric heater to raise the temperature of the electric storage device in the manual mode, and a second integrator that is configured to calculate an integrated value of the electric power consumed by the electric heater to raise the temperature of the electric storage device in the automatic mode, and
the power consumption determiner is further configured to compare the integrated value calculated by the first integrator with the first reference value in the manual mode, and compare the integrated value calculated by the second integrator with the second reference value in the automatic mode.

5. The heating system as claimed in claim 1, further comprising:
a heat sensor that detects an amount of energy consumed by the electric heater to raise the temperature of the electric storage device,
wherein the integrator is further configured to calculate the integrated value of the electric power consumed by the electric heater to raise the temperature of the electric storage device:
by integrating an amount of the energy detected by the heat sensor; or
based on a length of time from a point at which the heating of the electric storage device is commenced and an amount of the energy consumed per predetermined unit of time, in a situation where the amount of energy consumed by the electric heater cannot be detected by the heat sensor.

6. The heating system as claimed in claim 1, wherein the controller further comprises:
a heating inhibitor that is configured to maintain the cessation of the heating of the electric storage device after the heating of the electric storage device is terminated by the heating controller, and inhibit the heating of the electric storage device until a predetermined condition is satisfied.

7. The heating system as claimed in claim 2, wherein the controller further comprises:
a heating inhibitor that is configured to maintain the cessation of the heating of the electric storage device after the heating of the electric storage device is terminated by the heating controller, and inhibit the heating of the electric storage device until a predetermined condition is satisfied.

8. The heating system as claimed in claim 3, wherein the controller further comprises:
a heating inhibitor that is configured to maintain the cessation of the heating of the electric storage device after the heating of the electric storage device is terminated by the heating controller, and inhibit the heating of the electric storage device until a predetermined condition is satisfied.

9. The heating system as claimed in claim 4, wherein the controller further comprises:
a heating inhibitor that is configured to maintain the cessation of the heating of the electric storage device after the heating of the electric storage device is terminated by the heating controller, and inhibit the heating of the electric storage device until a predetermined condition is satisfied.

10. The heating system as claimed in claim 5, wherein the controller further comprises:
a heating inhibitor that is configured to maintain the cessation of the heating of the electric storage device after the heating of the electric storage device is terminated by the heating controller, and inhibit the heating of the electric storage device until a predetermined condition is satisfied.

11. The heating system as claimed in claim 7, wherein the predetermined condition includes a first condition that is employed in the manual mode, and a second condition different from the first condition that is employed in the automatic mode.

12. The heating system as claimed in claim 11,
wherein the first condition includes a fact that a main switch is turned off, and
the second condition includes a commencement of the charging of the electric storage device by the external charging facility.

13. A heating system, comprising:
an electric heater that heats an electric storage device arranged in a vehicle to raise a temperature of the electric storage device before charging the electric storage device by an external charging facility; and
a controller that controls a heating of the electric storage device by the electric heater,
wherein the controller comprises:
a selector that is configured to select a heating mode of the electric storage device from a manual mode in which the heating of the electric storage device is executed upon execution of a manual operation by an occupant of the vehicle, and an automatic mode in which the heating of the electric storage device is executed based on a detection signal of a condition of the vehicle; and
a heating inhibitor that is configured to
maintain a cessation of the heating of the electric storage device in the manual mode after terminating the heating of the electric storage device, and inhibit a restart of the heating of the electric storage device until a first condition is satisfied, and
maintain a cessation of the heating of the electric storage device in the automatic mode after terminating the heating of the electric storage device, and inhibit a restart of the heating of the electric storage device until a second condition is satisfied.

14. The heating system as claimed in claim 13,
wherein the first condition includes a fact that a main switch is turned off, and
the second condition includes a commencement of the charging of the electric storage device by the external charging facility.

15. The heating system as claimed in claim 13, wherein the heating inhibitor is further configured to:
permit the restart of the heating of the electric storage device in the automatic mode when the first condition is not satisfied but the second condition is satisfied; and
permit the heating of the electric storage device in the manual mode when the second condition is not satisfied but the first condition is satisfied.

16. The heating system as claimed in claim 14, wherein the heating inhibitor is further configured to:
permit the restart of the heating of the electric storage device in the automatic mode when the first condition is not satisfied but the second condition is satisfied; and
permit the heating of the electric storage device in the manual mode when the second condition is not satisfied but the first condition is satisfied.
